(19) United States
(12) Patent Application Publication
(10) Pub. No.: US 2016/0088419 A1
(43) Pub. Date: Mar. 24, 2016

(54) MOBILE DEVICE APPLICATION PRIORITIZATION BASED ON CONTEXT

(71) Applicant: QUALCOMM Incorporated, San Diego, CA (US)

(72) Inventors: Koushik Annapureddy, Tampere (FI); Keir Finlow-Bates, Kangasala (FI)

(73) Assignee: QUALCOMM INCORPORATED, San Diego, CA (US)

(21) Appl. No.: 14/495,653

(22) Filed: Sep. 24, 2014

(51) Int. Cl. H04W 4/00; H04W 4/02; H04L 29/08; H04W 24/08; H04M 1/725

(52) U.S. Cl. CPC H04W 4/003; H04W 24/08; H04M 1/72569; H04L 67/18; H04W 4/027

(57) ABSTRACT

Systems and methods for prioritizing a plurality of applications associated with a mobile device involve determining at least one attribute associated with each of the plurality of applications, and determining at least one of a current position, current travel speed, or current time in response to a triggering event. Also, expected network performance data is determined based on at least one of the current position, current travel speed, and current time associated with a user device or with other mobile devices. Prioritized applications are selected from the plurality of applications based on the expected network performance and at least one attribute associated with each of the applications.

### BACKGROUND

1. Field

Embodiments described herein generally relate to prioritizing mobile device applications.

2. Background

A mobile device (e.g., a smart phone or a tablet) may be capable of executing various applications, each of which may require battery power, network resources, and processing power. However, if the mobile device has low battery power, then using applications with high battery consumption may quickly deplete the remaining battery power and induce a negative user experience. Similarly, a negative user experience may occur when the mobile device can access only limited network resources. For example, applications with high network demand (i.e., high quality of service (“QOS”) requirement) may deprive other applications of the network resources.

A user of the mobile device may not be aware of particular applications' negative impact on battery power, network resources, and/or processing power. Typically, the user has no way of assessing the requirements of each application. For example, the typical user would not have determined the detrimental effect of certain application before using those applications. Even after use, the user may not become aware of the identities of applications that may be the cause of a negative user experience, given that numerous applications are typically running simultaneously on the mobile device.

In particular, users of modern mobile devices tend to favor applications that require data usage. Thus, high reliance on data traffic may be required. Data traffic from a given mobile device can be many times as great as voice traffic. However, various factors currently exist that can negatively impact the user experience related to data usage and power consumption requirements of applications of the mobile devices. For example, different locations may be associated with different natural or artificial attributes that negatively impact network performance. Furthermore, the attention span of a user on certain applications may be short, such that the user may switch to or be distracted by other applications when a certain application does not respond within an expected or reasonable time period.

### SUMMARY

Various embodiments generally relate to prioritizing a plurality of applications associated with a mobile device. A method according to various embodiments includes: determining at least one attribute associated with each of the plurality of applications, the at least one attribute comprising at least one of battery power consumption, quality of service (QOS) requirement, uplink speed requirement, downlink speed requirement, or processing power consumption; detecting a triggering event; determining expected device resources, the expected device resources indicate projected device resources available for executing the plurality of application in response to the triggering event; and prioritizing applications from the plurality of applications based on the expected device resources and the at least one attribute associated with each of the plurality of applications.

In some embodiments, the method further includes determining at least one of a current position, current travel speed, or current time in response to the triggering event. The expected device resources comprise expected network performance data. The expected network performance data is associated with a plurality of secondary mobile devices.

In some embodiments, the expected network performance data comprises at least one of expected network type or expected uplink speed. Expected downlink speed associated with at least one of a plurality of positions, a plurality of travel speed ranges, or a plurality of time intervals.

In various embodiments, the determining the expected network performance data includes at least one of: matching the current position with one of the plurality of positions; matching the current travel speed with one of the plurality of travel speed ranges; or matching the current time to one of the plurality of time intervals.

For some embodiments, the determining the expected network performance data further includes retrieving the expected network performance data based on one or more of the matched position of the plurality of positions, the matched travel speed range of the plurality of travel speed ranges, and the matched time interval of the plurality of time intervals.

In some embodiments, the expected network performance data is an average network performance data determined based on secondary network performance data associated with each of the plurality of secondary mobile devices.

In some embodiments, the prioritizing applications from the plurality of applications based on the expected device resources and the at least one attribute associated with each of the plurality of applications includes selecting prioritized applications from the plurality of applications based on the expected network performance and the at least one attribute associated with each of the plurality of applications.

In some embodiments, the method further includes transmitting an actual network performance and at least one of the current position, the current travel speed, or the current time to a remote server.

In various embodiments, the actual network performance and the at least one of the current position, the current travel speed, or the current time are transmitted to a remote server in a same data unit.

In some embodiments, the method further includes receiving expected network performance from the remote server.

In some embodiments, the determining the at least one attribute includes monitoring the application for a predetermine period of time; storing sample values associated with the attribute; and determining an attribute average value based, at least in part, on the sample values.

In some embodiments, the triggering event includes at least one of: the mobile device entering or exiting a predetermined area; the mobile device arriving at a predetermined position; the mobile device entering or existing the predetermine area while traveling at a predetermined speed; the mobile device is entering or existing the predetermine area within a predetermined time interval; or the mobile device is entering or existing the predetermined area while traveling at a predetermined speed and within the predetermined time interval.

In some embodiments, the triggering event comprises at least one of: the mobile device being camped on a predetermined network; the mobile device having a predetermined uplink speed; or the mobile device having a predetermined download speed.

In various embodiments, the method further includes prioritizing the prioritized applications, wherein the prioritizing the prioritized applications comprises at least one of: shifting the prioritized applications to at least one initial screen; displaying the prioritized applications before displaying at least one un-prioritized application; displaying the prioritized applications in a first graphical state; or displaying the un-prioritized applications in a second graphical state, wherein the first graphical state and the second graphical state are different graphical states.

In various embodiments, an mobile device includes a processor, the processor configured to: determine at least one attribute associated with each of the plurality of applications, the at least one attribute comprising at least one of battery power consumption, quality of service (QOS) requirement, uplink speed requirement, downlink speed requirement, or processing power consumption; detecting a triggering event; determine expected device resources, the expected device resources indicate projected device resources available for executing the plurality of application in response to the triggering event; and select prioritized applications from the plurality of applications based on the expected device resources and the at least one attribute associated with each of the plurality of applications.

In some embodiments, the processor is further configured to: determine at least one of a current position, current travel speed, or current time in response to the triggering event. The expected device resources comprises expected network performance data; and the expected network performance data is associated with a plurality of secondary mobile devices.

In some embodiments, the expected network performance data comprises at least one of expected network type, expected uplink speed, or expected downlink speed associated with at least one of a plurality of positions, a plurality of travel speed ranges, or a plurality of time intervals.

In various embodiments, the determining the expected network performance data comprises at least one of: matching the current position with one of the plurality of positions; matching the current travel speed with one of the plurality of travel speed ranges; or matching the current time to one of the plurality of time intervals.

In some embodiments, the determining the expected network performance data further includes retrieving the expected network performance data based on one or more of the matched position of the plurality of positions, the matched travel speed range of the plurality of travel speed ranges, and the matched time interval of the plurality of time intervals.

According to some embodiments, a method for prioritizing a plurality of applications associated with a mobile device is described, the method includes: determining at least one attribute associated with each of the plurality of applications, the at least one attribute comprising at least one of battery power consumption, quality of service (QOS) requirement, uplink speed requirement, downlink speed requirement, or processing power consumption; detecting a triggering event; determining expected device resources, the expected device resources indicate projected device resources available for executing the plurality of application in response to the triggering event; and prioritizing applications from the plurality of applications based on the expected device resources and the at least one attribute associated with each of the plurality of applications.

### BRIEF DESCRIPTION OF THE DRAWINGS

FIG. 1 is a schematic diagram illustrating an example of a mobile device application prioritization system according to various embodiments.

FIG. 2 is a method flowchart illustrating a mobile device application prioritization method according to various embodiments.

FIG. 3 is method flowchart illustrating an example of a network context determination method 400 according to various embodiments.

FIG. 4 is method flowchart illustrating an example of a mobile device application prioritization method based on crowd-sourced network performance data according to various embodiments.

FIG. 5 is a method flowchart illustrating another example of a mobile device application prioritization method based on crowd-sourced network performance data according to various embodiments.

FIG. 6 is method flowchart illustrating yet another example of a mobile device application prioritization method based on crowd-sourced network performance data according to various embodiments.

FIG. 7a-7b are example screens displaying prioritized and/or un-prioritized applications according to various embodiments.

FIG. 8 is another example screen displaying prioritized and/or un-prioritized applications according to various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the invention or the claim.

Embodiments described herein relate to prioritizing one or more applications based on attributes of the applications on the mobile device, such that a first group of applications may be prioritized over a second group of applications when it is determined that executing the first group of applications is appropriate for a current context of the mobile device, while executing the second group is not.

The mobile device may be configured to determine the context of the mobile device. Context refers to resources accessible by the mobile device made available for executing applications and other mobile functions. The context may be characterized by context parameters such as remaining battery power, current geographic location, available network resources (type of network that the device is or could be camping on), network handovers, potential uplink network speed, potential downlink network speed, current display and other application settings, available processing power (based on background scheduled applications and other processes), and the like.

Each application may correspond to one or more attributes, such as battery power consumption, network resources usage (for example, based on QOS requirements), uplink speed requirement, downlink speed requirement, processing power usage, and the like. One or more attributes correspond to at least one context parameter of the mobile device. When an application is executed on the mobile device, the mobile device monitors the attributes associated with the application for a predetermined period of time and classifies the application based on the monitored attributes. For example, when an application consumes less battery power on average than a threshold during its execution within a predetermined period of time, then the application is classified as non-battery-power-intensive; where an application's QOS requires less bandwidth/speed than a threshold on average within a predetermined period of time, then the application is classified as non-network-intensive; where an application requires less processing power than a threshold during its execution on average within a predetermined period of time, it is classified as non-processing-power-intensive.

An application suggestion/prioritization mechanism may be triggered when the value of one or more context parameters reaches a predetermined threshold. When triggered, the mobile device may suggest and/or prioritize applications that are non-battery-power-intensive, non-network-intensive, and/or non-processing-power-intensive over other applications. For example, when remaining battery power reaches a predetermined level, and the mobile device is determined to be not within a predetermined geographic area around (within a predefined proximity of) one or more geographic locations where the mobile device has been (or could be) charged, the mobile device may prioritize non-battery-power-intensive and/or non-processing-power-intensive applications. In another example, when the network camped on is a 3G network (or other predefined network having limited network resources relative to other networks), the mobile device may prioritize non-network-intensive applications.

The prioritized applications may be shifted to initial screen(s) (e.g., the first or default screen displayed by the mobile device without any user input), while the other applications may be shifted to later screen(s). In particular embodiments, the later screen(s) follow (are displayed after) the initial screen(s) and require additional user input to be displayed (such as, but not limited to an input for scrolling, changing a screen page or viewing a next screen page). In alternative/further examples, the prioritized applications may be represented by a graphical state (such as, but not limited to green or other predefined color, highlighted or boxed) indicating priority, while the un-prioritized applications may appear in at least one different graphical state (such as, but not limited to red or other predefined color, not highlighted, not boxed).

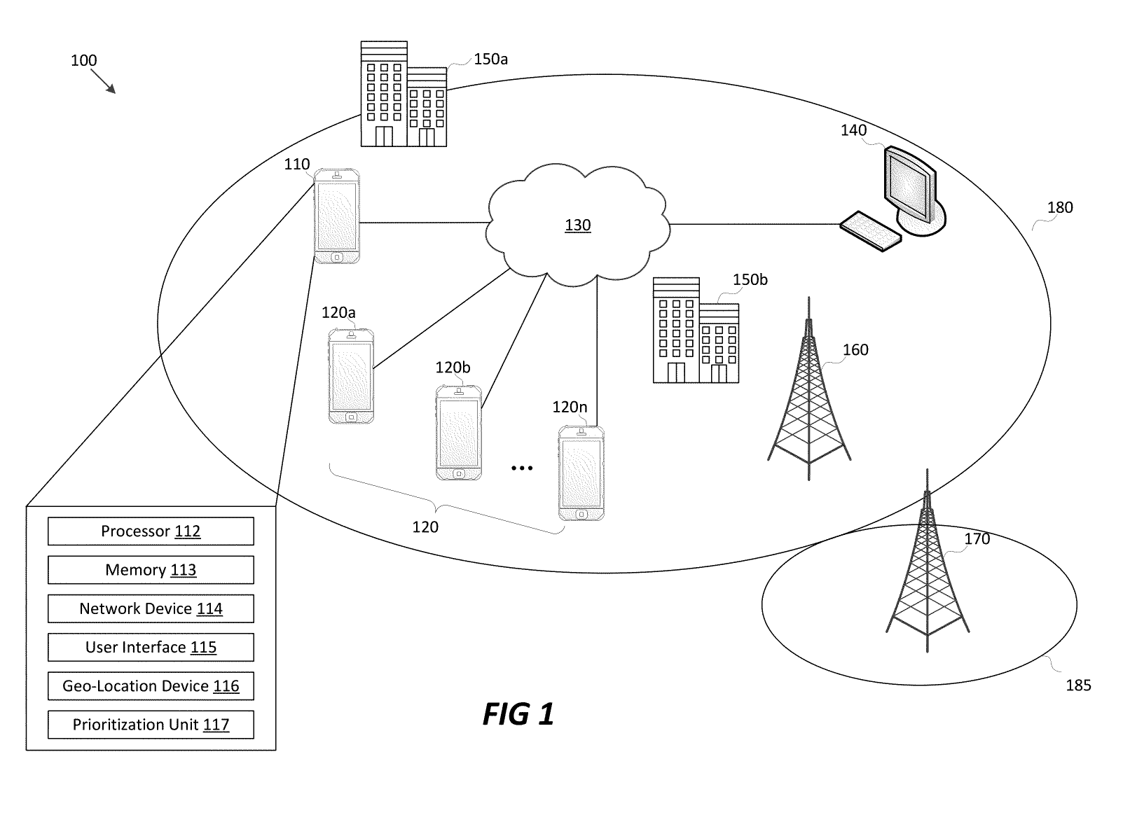

With reference to FIG. 1, a schematic diagram of a mobile device application prioritization system 100 is shown in accordance with various embodiments. The system 100 according to various embodiments includes at least one first mobile device 110 and may include one or more additional mobile devices 120 (e.g., a first additional mobile device 120a, a second additional mobile device 120b, . . . , a n^{th} additional mobile device 120n, and/or the like), as well as a network 130, a server 140, a first base station 160 associated with a first region 180, and a second base station 170 associated with a second region 185. One or more buildings, mountains, or other natural or manmade structures (such as a first structure 150a and a second structure 150b) may be located in the region 180. Similarly, one or more further natural or manmade structures (not shown) may be located in the second region 185.

Each of the first mobile device 110, the additional mobile devices 120, and the server 140, may be connected for communication with one another through a network 130. The first mobile device 110, the additional mobile devices 120, and the server 140 may be programmed or otherwise configured to operate and provide functions described herein.

In some embodiments, the first mobile device 110 and the additional mobile devices 120 may be associated with users (for example, but not limited to, different respective users). For example, a first user may be associated with the first mobile device 110 and additional users may be associated with each of the additional mobile devices 120. Each of the first mobile device 110 and the additional mobile devices 120 may be configured to execute various applications, some of which require user interaction with the associated users.

In various embodiments, the network 130 may allow data transfer between the additional mobile devices 120, and the server 140. The network 130 may be a wide area communication network, such as, but not limited to, the Internet, or one or more Intranets, local area networks (LANs), ethernet networks, metropolitan area networks (MANs), a wide area network (WAN), combinations thereof, or the like. The network 130 may also be one or more of networks provided by various radio access technologies such as, but not limited to, Global Standard for Mobile (GSM), Code Division Multiple Access (CDMA), CDMA2000, Time Division Code Division Multiple Access (TDCDMA), Time Division Synchronous Code Division Multiple Access (TDSCDMA), Wideband Code Division Multiple Access (WCDMA), Time Division Multiple Access (TDMA), Frequency Division Multiple Access (FDMA), Long-Term Evolution (LTE), Voice over LTE (VoLTE), Simultaneous GSM and LTE (SGLTE), Simultaneous Voice and LTE (SVLTE), and/or the like.

In particular embodiments, the network 130 may represent one or more secure networks configured with suitable security features, such as, but not limited to firewalls, encryption, or other software or hardware configurations that inhibits access to network communications by unauthorized personnel or entities.

The server 140 may include at least one processor, memory operatively coupled to the processor, and at least one network device. In some embodiments, the server 140 may include a desktop computer, mainframe computer, laptop computer, pad device, smart phone device or the like, configured with hardware and software to perform operations described herein. For example, the server 140 may comprise typical desktop PC or Apple™ computer devices, having suitable processing capabilities, memory, user interface (e.g., display and input) capabilities, and communication capabilities, when configured with suitable application software (or other software) to perform operations described herein.

Thus, particular embodiments may be implemented, using processor devices that are often already present in many business and organization environments, by configuring such devices with suitable software processes described herein. Accordingly, such embodiments may be implemented with minimal additional hardware costs. However, other embodiments of the server 140 may relate to systems and methods that are implemented with dedicated device hardware specifically configured for performing operations described herein.

The processor may include any suitable data processing device, such as a general-purpose processor (e.g., a microprocessor), but in the alternative, the processor may be any conventional processor, controller, microcontroller, or state machine. The processor may also be implemented as a combination of computing devices, e.g., a combination of a DSP and a microprocessor, a plurality of microprocessors, at least one microprocessors in conjunction with a DSP core, or any other such configuration. The memory may be operatively coupled to the processor and may include any suitable device for storing software and data for controlling and use by the processor to perform operations and functions described herein, including, but not limited to, random access memory RAM, read only memory ROM, floppy disks, hard disks, dongles or other RSB connected memory devices, or the like.

The network device of the server 140 may be configured for connection with and communication over the network 130. The network device may include interface software, hardware, or combinations thereof, for connection with and communication over the network 130. The network device may include wireless receiver or transceiver electronics and/or software that provides a wireless communication link with the network 130 (or with a network-connected device). In addition to (or as an alternative to) the memory, the server 140 may be operatively coupled to the at least one database (not shown). In some embodiments, the database may be connected to the server 140 through the network 130. In other embodiments, the database may be connected to the server 140 in other suitable manners not through the network 130. In particular embodiments, the database may be capable of storing a greater amount of information and provide a greater level of security against unauthorized access to stored information, than the memory in the server 140. The network 130 may include various types of networks such as various cell data networks, telecommunication networks, various types of wireless networks, and/or the like.

The first base station 160 and the second base station 170 may each include at least one antenna group or transmission stations located at different areas within first region 180 or the second region 185, respectively, and associated with signal transmission and reception. The first base station 160 and the second base station 170 may each include one or more processors, modulators, multiplexers, demodulators, demultiplexers, antennas, and the like for performing the functions described herein. In some embodiments, the first base station 160 and/or the second base station 170 may be utilized for providing communication access for the first mobile device 110 and the additional mobile devices 120. The first base station 160 and the second base station 170 may each be an access point, Node B, evolved Node B (eNode B or eNB), base transceiver station (BTS), or the like. In some embodiments, the first base station 160 may provide the network 130.

First region 180 may be an area associated with the first base station 160 such that the first mobile device 110 and the additional mobile devices 120, when located within first region 180, may acquire service from the first base station 160 (e.g., receive signals from and transmit signals to the first base station 160). The second region 185 may be an area associated with the second base station 170. The various mobile devices similar to the first mobile device 110 and the additional mobile devices 120 (and/or the first mobile device 110 and the additional mobile devices 120 themselves) may acquire service from the second base station 170 when located within the second region 185. In some embodiments, first region 180 and the second region 185 may each represent a separate region relative to the other. The first region 180 and the second region 185 may each represent a continent, a country, a region, a state, a province, a city, or other geographic area having definable boundaries. In some embodiments, first region 180 and the second region 185 may be entirely separate from one another such that no portions of first region 180 and the second region 185 may overlap, while in alternative embodiments, at least a portion of first region 180 and the second region 185 may overlap.

Various environmental factors may affect (e.g., hinder, or in some cases, boost) network resources as experienced by the first mobile device 110 (and the additional mobile devices 120). Such environmental factors may include, but are not limited to, fading, interference, displacement from a base station (e.g., from the first base station 160), natural structures (such as, but not limited to a mountain), artificial structures (such as, but not limited to one or more buildings represented by a first structure 150a and a second structure 150b), interference from signals transmitted by other base stations (e.g., the second base station 170) for another cell (e.g., the second region 184), the number of (active) additional mobile devices 120 also present within the cell (e.g., the first region 180) and/or also connected to the network provided by the first base station 160. Typically, the peak network speed may be experienced at the center of the cell (e.g., the first region 180) while lower network speed may be experienced at the edge of the cell.

The environmental factors may affect network resources differently from one position or geographic area to another. In addition, environmental factors may affect network resources (e.g., type of network, uplink speed, downlink speed, separate or in combination) differently with respect to time and/or speed. For example, in a flash mob event or a concert, many additional mobile devices 120 (e.g., as carried by their respective users) may congregate in a specific area within a specific timeframe. The additional mobile devices 120 may be operated by their respective users to upload or download pictures and/or videos. Thus, network speed (e.g., especially uplink speed, as many users may upload pictures or videos) may be reduced for the first mobile device 110. Additionally, the travel speed (geological velocity) of the first mobile device 120 may also affect network speed experienced by the first mobile device 120. Accordingly, network speed experienced by the first mobile device 110 may fluctuate with respect to location, time, and/or travel speed.

The mobile device 110 (and/or the additional mobile devices 120) may include at least one processor 112, memory 113 operatively coupled to the processor 112, network device 114, user interface 115, and a geo-location device 116.

The processor 112 may include any suitable data processing device, such as, but not limited to, a general-purpose processor (e.g., a microprocessor). In the alternative, the processor 112 may be any conventional processor, controller, microcontroller, or state machine. The processor 112 may also be implemented as a combination of computing devices, e.g., a combination of a DSP and a microprocessor, a plurality of microprocessors, at least one microprocessors in conjunction with a DSP core, or any other such configuration.

The memory 113 may be operatively coupled to the processor 112 and may include any suitable device for storing software and data for controlling and use by the processor 112 to perform operations and functions described herein. Examples of the memory 113 may include, but not limited to, random access memory RAM, read only memory ROM, floppy disks, hard disks, dongles or other RSB connected memory devices, or the like.

The network device 114 may be configured for communication over the network 130. The network device 114 may include interface software, hardware, or combinations thereof, for connection with and communication over the network 130. The network device 114 may include wireless receiver/transceiver electronics and software that provide a wireless communication link (both uplink and downlink) with the network 130 (or with a device connected to the network 130). In particular embodiments, the network device 114 may operate with the processor 112 for providing cell data networks, telecommunication networks, Wi-Fi networks, various other types wireless networks, and/or the like.

The user interface 115 may include at least a display device. The display device may include any suitable device that provides a human-perceptible visible signal, audible signal, tactile signal, or any combination thereof, including, but not limited to a touchscreen, LCD, LED, CRT, plasma, other suitable display screen, audio speaker, other audio generating device, combinations thereof, and/or the like.

In some embodiments, the user interface 115 of the mobile device 110 may further include at least one user input device configured to provide an interface for the users to interact with the applications executed on the mobile device 110. The user input device may include any suitable device that receives input from the user including, but not limited to, one or more manual operator (such as, but not limited to a switch, button, touchscreen, knob, slider or the like), microphone, camera, image sensor, or the like.

The geo-location device 116 may include hardware and software for determining geographic location of the mobile device 110, such as, but not limited to a global positioning system (GPS) or other satellite positioning system, terrestrial positioning system, Wi-Fi location system, combinations thereof, or the like.

In addition, the mobile device 110 (and/or the additional mobile devices 120) may include a prioritization unit 117 configured to perform the mobile application prioritization methods as described herein. In particular, the prioritization unit 117 may include the processor 112, the memory 113, the network device 114, the user interface 115, the geo-location device 116, and/or the like. In some embodiments, the prioritization unit 117 may include additional or different processor, memory, network device, user interface, geo-location device, and/or the like specialized for the prioritization method. As referenced herein, names for sub-components of the prioritization unit 117 (e.g., the processor 112, the memory 113, the network device 114, the user interface 115, the geo-location device 116, and/or specialized devices as described herein) may be used for clarity.

In particular embodiments, the mobile device 110 (e.g., the first mobile device 110 and additional mobile devices 120) may be a mobile smart phone (such as, but not limited to an iPhone™, an Android™, or the like) or other mobile cellular phone with suitable processing capabilities. Typical modern mobile phone devices include telephone communication electronics as well as some processor electronics, one or more display devices and a keypad and/or other user input device, such as, but not limited to described herein. Particular embodiments employ mobile phones, commonly referred to as smart phones, that have relatively advanced processing, input and display capabilities in addition to telephone communication capabilities. However, the first mobile device 110, in further embodiments of the present invention, may include any suitable type of mobile phone and/or other type of portable electronic communication device, such as, but not limited to, an electronic smart pad device (such as, but not limited to an iPad™), a portable laptop computer, or the like.

In embodiments in which the mobile device 110 is a smart phone or other mobile phone device, the mobile device 110 may have existing hardware and software for telephone and other typical wireless telephone operations, as well as additional hardware and software for providing functions as described herein. Such existing hardware and software includes, for example, one or more input devices (such as, but not limited to keyboards, buttons, touchscreens, cameras, microphones, environmental parameter or condition sensors), display devices (such as, but not limited to electronic display screens, lamps or other light emitting devices, speakers or other audio output devices), telephone and other network communication electronics and software, processing electronics, electronic storage devices and one or more antennae and receiving electronics for receiving various signals. In such embodiments, some of that existing electronics hardware and software may also be used in the systems and methods for functions as described herein.

Accordingly, such embodiments can be implemented with minimal additional hardware costs. However, other embodiments relate to systems and methods that are implemented with dedicated device hardware specifically configured for performing operations described herein. Hardware and/or software for the functions may be incorporated in the mobile device 110 during manufacture of the mobile device 110, for example, as part of the original manufacturer's configuration of the mobile device 110. In further embodiments, such hardware and/or software may be added to the mobile device 110, after original manufacture of the mobile device 110, such as by, but not limited to, installing one or more software applications onto the mobile device 110.

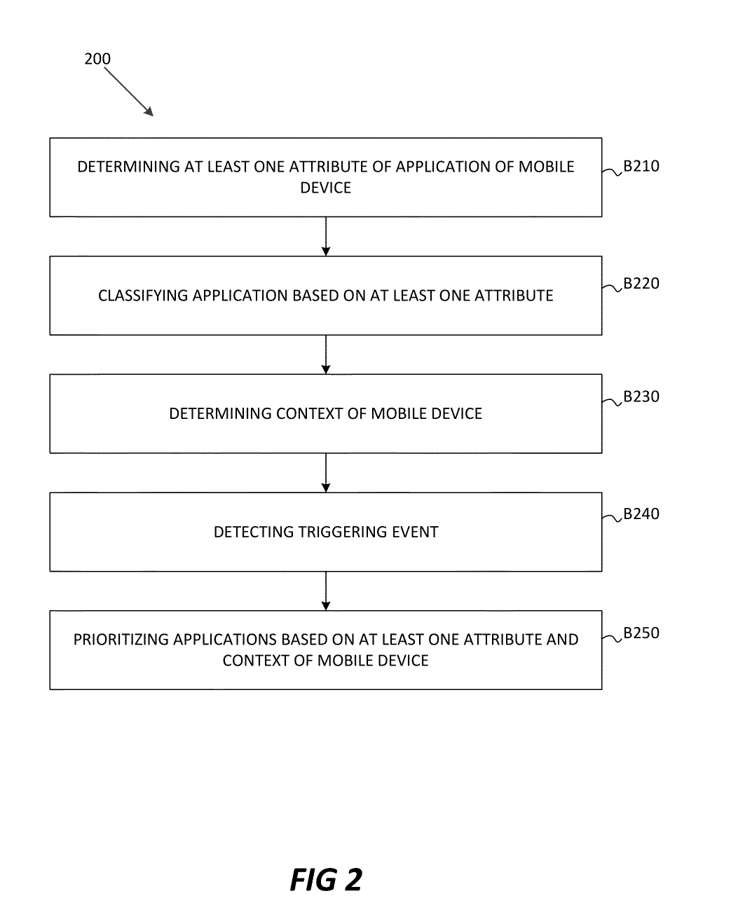

A method flowchart of a mobile device application prioritization method 200 is illustrated in FIG. 2 according to various embodiments. With reference to FIGS. 1-2, first at block B210, at least one attribute of an application of the mobile device 110 may be determined via the processor 112. The application may be either executed (e.g., for one or more times by the processor 112 of the mobile device 110) or yet to be executed for the first time. Each application of the mobile device 110 may correspond to one or more attributes. The attributes may refer to the behavior or characteristics of the mobile device 110 as caused by the execution of the application. Examples of attributes may include, but not limited to, battery power consumption, network resources usage (based on QOS requirements, uplink speed requirement, downlink speed requirement, and/or the like), processing power usage, and/or the like.

When an application is executed on the mobile device 110, the mobile device 110 may monitor the at least one attribute associated with the application for a predetermined period of time (e.g., for 30 minutes, 6 hours, a day, one week, one month, a year, indefinitely, and/or the like) for one or more times. During the predetermined period of time, the mobile device 110 may assess each of the at least one attributes of the application every time the application is initiated (executed) with the processor 112 of the mobile device 110. The mobile device 110 may store various attribute parameters in the memory 113.

By way of illustrating with a non-limiting example, each instance for which a first application is initiated/executed, the mobile device 110 (e.g., through the processor 112) may monitor power consumption due to active and/or passive (background software) execution of the application for calculating a rate of power consumption. The mobile device may similarly monitor the network resources consumed by the application, the QOS requirements of the application when executed, uplink speed required when executed, downlink speed required when executed, processing power usage when executed, a combination thereof, and/or the like. These attributes may be monitored for both active and passive execution of the application. In a particular example, a first application is monitored to have consumed X-joules (of processing power) over a 4G network for 30 minutes, yet it consumes Y-joules over a 3G network over 30 minutes.

The attribute parameters may be stored in the memory 113 for subsequent operations after being determined by the processor 112 of the mobile device 110. One or more average attribute parameter values may be calculated from the data accumulated with respect to the application. Accordingly, it is possible to obtain the average attribute parameter values and/or the classifications of all applications on a mobile device over time.

In other embodiments, the mobile device 110 may forego monitoring the applications with respect to various attributes. Instead, the mobile device 110 may extract relevant application specifications (e.g., as indicated by the creators of the applications) from the applications for stated attribute parameter values. The stated attribute parameter values may include, but not limited to, a stated maximum power consumption rate, a stated uplink speed requirement, a stated downlink speed requirement, a stated quality of service, a stated processing power requirement, and/or the like.

Next at block B220, the processor 112 of the mobile device 110 may classify the application based on the at least one attribute monitored (e.g., based on the average attribute parameter values for various attributes of the application). Typically, applications of the mobile device 110 may be determined to be in one of a plurality of attribute classifications (levels). The application may be classified to be within a specific classification when the average attribute parameter value (or other suitable indicator of the performance with respect to the particular attribute, e.g., the stated attribute parameters) is within a predetermined range associated with the specific classification.

With respect to battery power consumption, an example with two classifications is illustrated. When an application consumes less battery power (as indicated by an average battery power consumption value) than a predetermined threshold during its execution (e.g., over a predetermined period of time), the application may be classified as non-battery-power-intensive. On the other hand, when the application consumes more battery power on average than the threshold during its execution within a predetermined period of time, then the application may be classified as battery-power-intensive. Three or more classification levels may be implemented in a similar manner.

With respect to network resources, an example with two classifications is illustrated. As described, network resources may refer to uplink speed, downlink speed, QOS requirement, and/or the like. When an application's consumes less network resources (as indicated by one or more average network resources consumption values) than a predetermined threshold, then the application may be classified as non-network-intensive (e.g., non-uplink-speed-intensive, non-downlink-speed-intensive, non-QOS-intensive, and/or the like). On the other hand, when the application's QOS requires more network resources than the predetermined threshold, then the application is classified as network-intensive (e.g., uplink-speed-intensive, downlink-speed-intensive, QOS-intensive, and/or the like).

In particular examples, streaming applications may depend on downlink throughput rates, and may therefore be downlink-intensive while not necessarily uplink-intensive. In other examples, real-time applications (e.g., video conferencing applications, multiplayer games) may depend on both downlink and uplink throughput rates. The real-time applications may be both downlink-intensive and uplink-intensive. In addition, browser applications, news applications, social media, and other applications may only depend on downlink throughput rates, and may be downlink-intensive.

With respect to processing power consumption, an example with two classifications is illustrated. When an application requires less processing power (as indicated by an average processing power consumption value) than a predetermined threshold during its execution (e.g., over a predetermined period of time), the application may be classified as non-processing-power-intensive. On the other hand, when the application consumes more processing power than the predetermined threshold, the application may be classified as processing-power-intensive. Three or more classification levels may be implemented in a similar manner.

In addition, additional classifications may be generated when a same application may be classified according to two or more different classifications described herein. For example, an application that is both non-network-intensive and non-processing-power-intensive may be classified as non-power-intensive. On the other hand, an application that is both network-intensive and processing-power-intensive may be classified as power-intensive.

One of ordinary skill in the art would appreciate that the applications may continue to be monitored despite that the average attribute parameter values may have already been determined based on previous execution and usage. Accordingly, the average attribute parameter values with respect to various attributes of the applications may continue to be updated with additional use or activation of the applications. In various embodiments, only samples taken with a predetermined time period (e.g., one week, one month, three months, or the like) before the current time may be used.

In other embodiments, the applications may be classified in a similar manner based on the stated parameters as extracted from the specifications (e.g., no monitoring or calculating for an average value may be required).

Next at block B230, the processor 112 of the mobile device 110 may determine a context of the mobile device 110. As described, context refers to resources accessible by the mobile device 110 for executing the applications (and other mobile functions of the mobile device 110). The context may be characterized by context parameters such as battery remaining, current location, available network resources (type of network that the device is or could be camping on), network handovers, potential (available) uplink network speed, potential (available) downlink network speed, current display and other application settings, available processing power (based on background scheduled applications and other methods), and the like. Each of the attributes parameters (e.g., the average attribute parameter value and/or the stated attribute parameter value as determined in block B210) may correspond to at least one of the context parameters.

For example, the processor 112 may determine the battery power remaining Such context parameter may correspond to the power consumption rate of the applications. In another example, a battery context parameter and/or a processing power parameter may be related to the current display and other application settings, available processing power, the background scheduled applications, and/or the like. The more graphic-intensive or bright the display settings are, a rate of power drain is faster. The power level may be high despite of high power consumption when the device is recently charged. The more numerous, processing-power intensive, or battery-power intensive the background schedule applications are, the more likely that the power remaining is low (and/or a rate of power drain is fast).

In addition, the processor 112 may determine the type of available networks that the mobile device 110 is (may potentially be) camping on. In particular, when the mobile device 110 is already camped, via the network device 114, on a 3G network (and/or when only the 3G network is available, and no other network may be available), a network context parameter may be determined to be an approximate network speed of the 3G network. Similarly, when the mobile device 110 is camped on a 4G network (and/or when the 4G network becomes available), the network context parameter may be determined to be an approximate network speed of the 4G network. The approximate network speed discussed herein may refer to the uplink network speed and/or the downlink network speed. The uplink network speed and/or the downlink network speed may be dependent on various factors described herein. Accordingly, the uplink network speed and the downlink network speed may be different.

In another example, another network context parameter may be based on network handovers. The context parameter may indicate a number of recent or potential network handovers (which may also be based on a speed by which the mobile device 110 is traveling). The more the number of recent or potential network handovers, the more likely that the mobile device 110 may be experiencing poor network connection.

In particular embodiments, the location of the mobile device 110 may determine a context parameter indicating the likelihood of recharging of the mobile device 110. The mobile device may be configure to detect (e.g., with the geo-location device 116) the location of the mobile device 110 when the mobile device 110 is being charged. The mobile device 110 may store a list of recorded locations where such charging event(s) have taken place. The current location of the mobile device may be compared with the recorded locations by the processor 112 of the mobile device 100. The context parameter may be assigned based on the distance between the current location and the recorded location. The closer the distance, the more likely that the mobile device 100 may be charged before the battery power reaches a critical level.

In addition, the location of the mobile device 110 may determine a context parameter indicating the potential network speed likely experienced by the mobile device 110 described in further detail herein.

In various embodiments, the context-determination step (e.g., illustrated with respect to block B230) may be executed sequential to the attribute-value-determination step (e.g., illustrated with respect to block B210) and/or the application classification step (e.g., illustrated with respect to block B220). In other embodiments, the context-determination step (e.g., illustrated with respect to block B230) may be executed contemporaneous with at least one of the attribute-value-determination step (e.g., illustrated with respect to block B210) and the application classification step (e.g., illustrated with respect to block B220).

Next at block B240, the processor 112 of the mobile device 110 may detect a triggering event, which may trigger the prioritization block B250. In some embodiments, the prioritization block B250 may be triggered when the value of one or more context parameters reaches a predetermined threshold. For example, when battery remaining reaches a predetermined level, the mobile device 110 (e.g., the processor 112) may be configured to prioritize applications based on power consumption. In another example, when the network camped on is a particular network associated with certain network speed (or when a particular network speed reaches a threshold), the mobile device 110 (e.g., the processor 112) may be configured to prioritize applications based on network resources usage. In yet another example, when processor usage (e.g., the usage of the processor 112) exceeds a predetermined percentage, then the mobile device 110 (e.g., the processor 112) may be configured to prioritize applications based on processing power usage.

Next at block B250, the processor 112 of the mobile device 110 may prioritize the applications based on the at least one attribute (as set forth by the average attribute parameter values, the stated attribute parameter values, and/or other attribute values) and the context (as set forth by the context parameter values). In other words, response to the triggering event, the processor 112 of the mobile device 110 may determine, based on the attribute classifications of an application, whether to prioritize the application in light of the context of the mobile device 110.

Efficient mobile device resource allocation may be achieved, given that the context parameters represent the available resources (battery power, network resources, processing power, and/or the like) of the mobile device 110, and attribute classifications and/or the average attribute parameter values (also the stated attribute parameter values) may represent resource requirement of an application.

With respect to battery power, the processor 112 may determine an overall battery power context for the mobile device 110 in response to the detection of the triggering event as described above. The overall battery power context may be based on one or a combination of context parameters such as, but not limited to, the battery remaining, current location (as related to possibility of recharging the battery), and the like. Additionally, network context parameters (e.g., available network resources, type of network that the device is or could be camping on, network handovers, potential/available uplink network speed, potential/available downlink network speed, and/or the like) and processing power context parameters (e.g., the current display and other application settings, scheduled/background applications, and/or the like) may also be considered in determining the overall battery power context. This is because rapid power drain may be a result of having inadequate network speed (e.g., cell searching) or over-consumption processing power.

Different levels of battery power context may correspond to prioritizing different attribute classifications (or average attribute parameter values). For example, the battery power context is determined to be critical or low, which may typically be the case, given at least one of the power context parameters (or other relevant parameters) was critical enough to trigger the prioritization method. In such situation, applications in one or more attribute classifications may be prioritized over applications in other attribute classifications. For example, applications that may be non-battery-power-intensive and/or power-intensive may be prioritized while battery-power-intensive and/or power-intensive applications may be unprioritized.

With respect to network resources, the processor 112 may determine an overall network resources context for the mobile device 110 in response to the detection of the triggering event as described. The overall network resources context may be based on one or a combination of context parameters such as, but not limited to, available network resources, type of network that the device is or could be camping on, network handovers, potential/available uplink network speed, potential/available downlink network speed, and/or the like).

Different levels of network resources context may correspond to prioritizing different attribute classifications (or average attribute parameter values). For example, the network resources context may be determined to be critical or low, which may typically be the case, given at least one of the network resources parameters (or other relevant parameters) was critical enough to trigger the prioritization method. In such situation, applications in one or more attribute classifications may be prioritized over applications in other attribute classifications. For example, applications that may be non-network-intensive and/or non-power-intensive may be prioritized while battery-power-intensive and/or power-intensive applications may be unprioritized when the network resources context may be deemed to be critical or scarce.

With respect to processing, the processor 112 may determine an overall processing power context for the mobile device 110 in response to the detection of the triggering event as described. The overall processing power context may be based on one or a combination of context parameters such as, but not limited to, the current display and other application settings, scheduled/background applications.

Different levels of processing power context may correspond to prioritizing different attribute classifications (or average attribute parameter values). For example, the processing power context is determined to be critical or low, which may typically be the case, given at least one of the processing power parameters (or other relevant parameters) was critical enough to trigger the prioritization method. In such situation, applications in one or more attribute classifications may be prioritized over applications in other attribute classifications. For example, applications that may be non-processing-power-intensive and/or non-power-intensive may be prioritized while processing-power-intensive and/or power-intensive applications may be unprioritized when the network resources context may be deemed to be critical or scarce.

In various embodiments, instead of determining based on attribute classifications of the application of interest (as set forth in block B220), the processor 112 of the mobile device 110 may determine whether to prioritize the application based directly on the average attribute parameter values or the stated attribute parameter values. For example, an application having an average attribute parameter value (or a stated attribute parameter value) exceeding/below a predetermined threshold in specified levels of mobile device context may be unprioritized/prioritized based on the nature of the threshold. In one example, applications with an average (or stated) processing power consumption (e.g., an average attribute parameter value) of more than X joules/s may be unprioritized. In another example, applications with an average (or stated) downlink speed requirement to be more than Y mb/s may be unprioritized.

In typical embodiments, some applications (as represented by icons or graphical elements being displayed by the user interface 115) may be prioritized by making these applications easily accessible. On the other hand, unprioritized application elements may be more difficult to access or even non-responsible when (attempted to) access with the user interface 115. In particular embodiments, the prioritized applications may be shifted to initial screen(s) (e.g., the first or default screens displayed by the user interface 115). The unprioritized applications may be shifted to later screen(s). The later screen(s) may follow the initial screen(s) and require additional user input to be displayed by the user interface 115.

In some embodiments, the prioritized applications may be represented in a graphical state (e.g., in a first color or of a boxed form) indicating priority. Unprioritized applications may appear in a different graphical state (e.g., in a second color which is different from the first, unboxed, shaded in, and/or the like). In some embodiments, a unprioritized application may be unresponsive when the user selects the icon or graphical element representing that application. In various embodiments, the icons and/or graphical elements representing the unprioritized applications may not be displayed by the user interface 115.

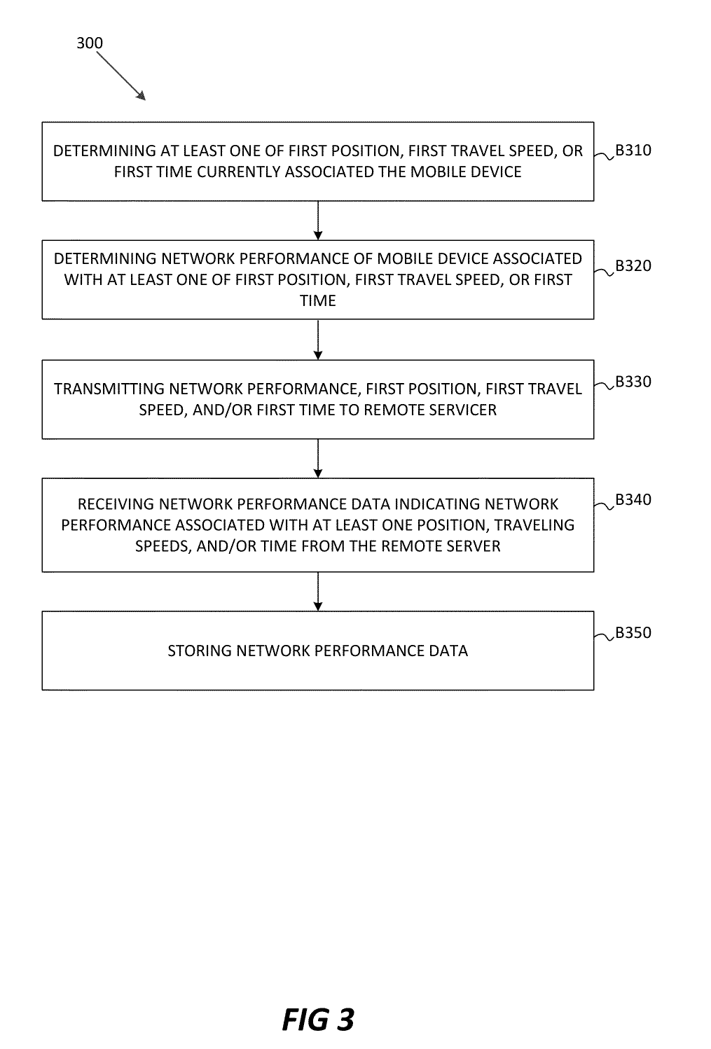

A method flowchart of an example of a network context determination method 300 is illustrated in FIG. 3 according to various embodiments. In some embodiments, the network context determination method 300 may be a particular implementation of block B230 of the mobile device application prioritization method 200 is illustrated in FIG. 2.

With reference to FIGS. 1-3, first at block B310, the mobile device 110 (e.g., the first mobile device 110) may be configured to determine at least one of a first position, a first travel speed, a first time (e.g., a current time) associated with the mobile device 110.

In some embodiments, the mobile device 110 may determine, with the geo-location device 116, a first position associated with the mobile device 110. In other words, the mobile device 110 may be configured to determine its own current location (e.g., with the geo-location device 116).

The mobile device 110 may also determine a first travel speed associated with the mobile device 110 which may be traveling. The mobile device 110 may determine the first travel speed with the processor 112, the geo-location device 116, and/or various sensors such as accelerometer.

The mobile device 110 may further determine a first time, the time being a current time. The mobile device 110 may determine the first time with the processor 112, and/or various timers/sensors not shown.

Next at block B320, the mobile device 110 may be configured to determine the network performance of the mobile device 110 associated with one or more of the first position, the first travel speed, and/or the first time. In some embodiments, the processor of the mobile device 110 may determine the type of network available, the type of networks camped on, the network speed (e.g., both uplink and downlink speed), nature of network handover, and/or the like. It follows that, the mobile device 110 may be configured to determine its own network context by determine the various network context parameters in the manner described at the first location, the first travel speed, and/or the first time.

The position, travel speed, and time determining step (e.g., block B310), the network performance determining step (e.g., block B320), may be executed simultaneously or sequentially in any suitable order.

Next at block B330, the mobile device 110 may be configured to transmit the network performance, the first position, the first travel speed, and/or the first time of the mobile device 110 to a remote server (e.g., the server 140) via the network device 114. The server 140 may be located at a separate node within the network 130. The network performance, the first position, the first travel speed, and/or the first time of the mobile device 110 may be aggregated into a single data unit. Each of the network performance, the first position, the first travel speed, and/or the first time within a same data unit may correspond to one another.

Next at block B340, the mobile device 110 may receive (e.g., via the network device 114) network performance data indicating potential network performance at various positions, travel speed, and/or time from the server 140. The various positions may include the first position, the various travel speed may include the first travel speed, and the various time may include the first time. The receiving of the network performance data may not be dependent on the transmitting of the network performance, the first position, the first travel speed, and/or the first time to the remote server. In some embodiments, the network performance data may include the network performance associated with one or more positions/travel speeds/times as transmitted to the server 140 by various mobile devices (e.g., the additional mobile devices 120 as well as the first mobile device 110).

In particular embodiments, a data unit of the network performance data may be a weighted average (or other suitable indicator) of network performance of the various mobile devices (e.g., such as the first mobile device 110, the additional mobile devices 120, and/or the like) with respect to a particular position, travel speed, and/or time. The network performance data may be a weighted factor indicating the average network performance/experience of the various mobile devices. The weighted factor may include various factors, each may correspond to a potential average uplink speed, potential average downlink speed, possibility to camp on a certain network (e.g., 3G, LTE, 4G, Wi-Fi, and/or the like).

Next at block B350, the mobile device 110 may be configured to store the network performance data in the memory 113. The memory 113 may store a plurality of data units including the network performance data. In other embodiments, the plurality of data units of the network performance data may be stored in the cloud, e.g., in the server 140. The mobile device 110 may be configured to receive the network performance data (and store in the memory 113 for temporary use of application prioritization) when the mobile device 110 is proximal to at least one of the plurality of positions.

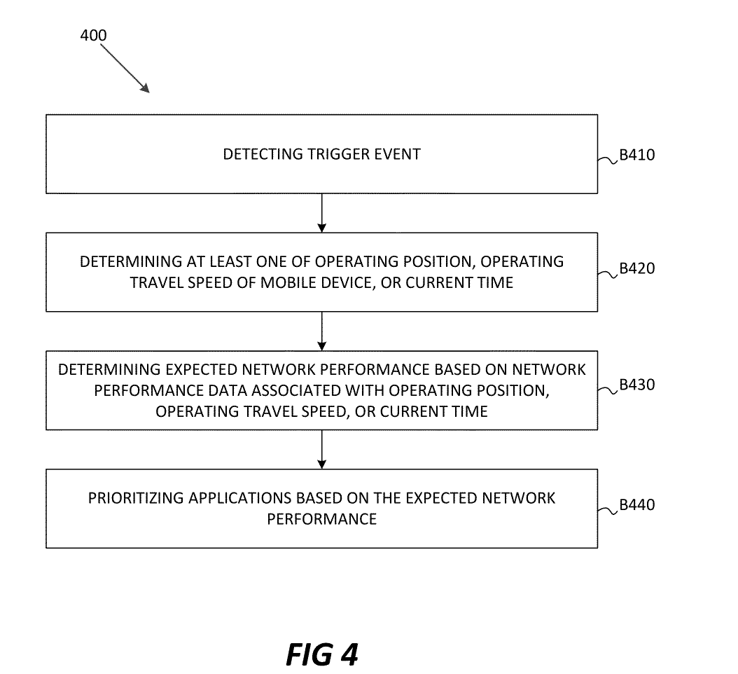

A method flowchart of an example of a mobile device application prioritization method 400 based on crowd-sourced network performance data is illustrated according to various embodiments in FIG. 4. In some embodiments, the mobile device application prioritization method 400 may be a particular implementation of blocks B240 and B250 of the mobile device application prioritization method 200 is illustrated in FIG. 2.

With reference to FIGS. 1-4, first at block B410, the mobile device 110 (e.g., the first mobile device 110) may be configured to detect a triggering event in the manner such as, but not limited to, described with respect to block B240. In particular, the triggering events may be network-related (e.g., the mobile device 110 may be camped on a particular network associated with certain network speed, when a particular network speed reaches a threshold, and/or the like). Other triggering events such as battery power or processing power may also be determined.

In various embodiments, the triggering event may be arrive at a specific position (entering or existing a predefined area) while traveling at a specific speed at a specific time. The method may be triggered when the mobile device 110 is travelling within a predetermined speed range within a predetermined time interval. For example, the triggering event may be entering or exiting an area (e.g., a “mall”) at null traveling speed (e.g., below 15 mph) on an afternoon of a weekend. In yet another example, the triggering event may be entering or exiting the area only. In another example, the triggering event may be entering or exiting the area with a speed range. In yet another example, the triggering event may be entering the area with a time interval.

Next at block B420, the mobile device 110 may be configured to determine at least one of an operating location, operating travel speed, and current time of the mobile device 110. For example, the mobile device 110 may determine an operating location via the geo-location device 116 in the manner described. In another example, the mobile device 110 may determine the travel speed of the mobile device 110 with the processor 112, the geo-location device 116, the accelerometer, and/or the like. The mobile device 110 may determine the current time with the processor 112 and/or various timers/sensors.

Next at block B430, the mobile device 110 may be configured to determine an expected network performance of the mobile device 110 based on the network performance data associated with at least one of the operating location, the operating travel speed, and the current time of the mobile device 110. The network performance data may include at least one weighted factor indicating the average network performance by the various mobile devices (e.g., the first mobile device 110 and the additional mobile devices 120). The weighted factor may include various factors, each may correspond to a possible average uplink speed, possible average downlink speed, possibility to camp on a certain network (e.g., 3G, LTE, 4G, Wi-Fi, and/or the like). Each of these weighted factor may correspond to a specific position (and a predetermined area surrounding the specific position), a travel speed, time and/or the like.

The mobile device 110 may, with the processor 112, extract the network performance data from the memory 113 based on the operating position, operating travel speed, and current time of the mobile device 110. In some embodiments, the expected network performance may include the network performance data corresponding to a position (and a predetermined area around the position) which may be the same position as the operating position. For example, network performance data associated with a mall (e.g., an area predetermined to be associated with the mall) may be used to assess the expected network performance of the mobile device 110 when the mobile device 110 has an operating position within the area predetermined to be associated with the mall. In another example, network performance data associated with a downtown (e.g., an area predetermined to be associated with the downtown) and a travel speed of 15 mph may be used to assess the expected network performance of the mobile device 110. The mobile device 110 may have an operating position within the area predetermined to be associated with the downtown, and the mobile device 110 may also have an operating travel speed within a predetermined ranged (e.g., within 5 mph, 10 mph, 15 mph, and/or the like).

In some embodiments, the network performance data may be stored on the memory 113 of the mobile device 110. In such embodiments, the mobile device 110 may locally access the network performance data and extract relevant data from the memory 113.

Accordingly, the mobile device 110 may assess potential network conditions corresponding to a position (area), speed, and/or time. This may occur before the mobile device 110 is actually camped on a network to have any information related to the network. Thus, the prioritization method may be based on the expected or potential network conditions.

Next at block B440, the applications of the mobile device 110 may be prioritized based on the expected network performance as determined by B430 at least in the manner described with respect to block B250. For example, the overall network resources context for the mobile device 110 may be the expected network performance obtained.

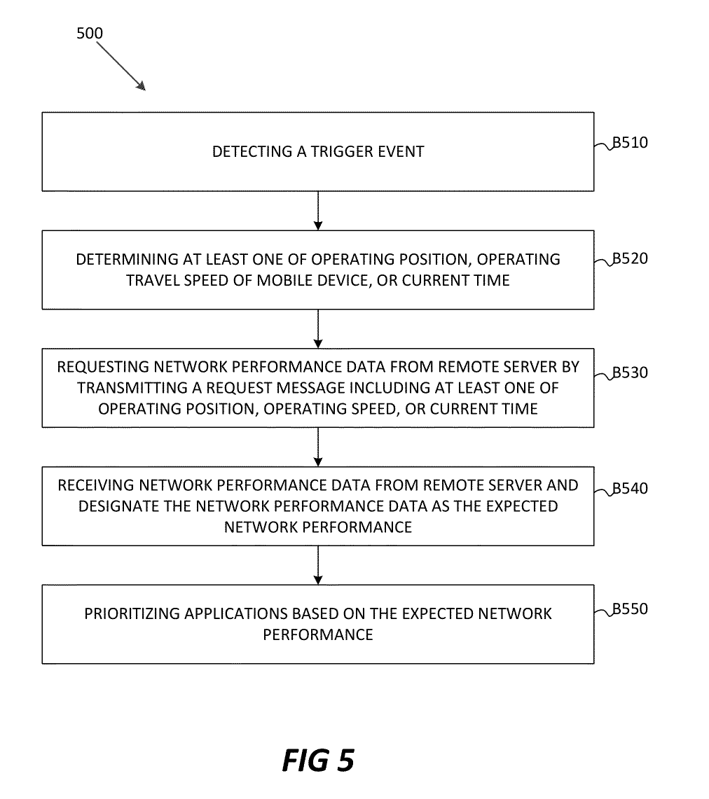

A method flowchart of an example of a mobile device application prioritization method 500 based on crowd-sourced network performance data is illustrated according to various embodiments by FIG. 5. In some embodiments, the mobile device application prioritization method 500 may be another implementation of blocks B240 and B250 of the mobile device application prioritization method 300 is illustrated in FIG. 3.

With reference to FIGS. 1-5, first at block B510, the mobile device 110 (e.g., the first mobile device 110) may be configured to detect a triggering event in the manner such as, but not limited to, described with respect to blocks B240 and B210.

Next at block B520, the mobile device 110 may be configured to determine an operating location, operating travel speed, and/or current time associated with the mobile device 110 in a manner such as, but not limited to, described with respect to blocks B420.

Next at blocks B530 and B540, the mobile device 110 may be configured to determine an expected network performance of the mobile device 110 based on the network performance data associated with the operating location, the operating travel speed, and/or the current time of the mobile device 110.

In block B530, the mobile device 110 may request network performance data from the remote server (e.g., the server 140) by transmitting a request message with the operating location, operating travel speed, and/or current time associated with the mobile device 110. The operating travel speed of the mobile device 110 may not be transmitted as a part of the request message when the mobile device 110 is determined to be not moving (e.g., when the traveling speed of the mobile device 110 is determined to be less than a predetermined threshold such as 5 mph, 7 mph, 10 mph, and/or the like).

In some embodiments, the network performance data may be data stored remotely (e.g., in the server 140). The entirety of network performance data (including data associated with various positions, travel speeds, time and/or the like) may not be downloaded to the mobile device 110 (e.g., stored in the memory 113) for storage. Instead, the mobile device 110 may request relevant network performance data on demand. For such embodiments, the mobile device 110 may sent a requesting message to the server 140, the message may include at least the operating location, operating travel speed, and/or current time associated the mobile device 110. The server 140 may include at least one database for storing and searching for network performance data. The network performance data may be indexed based on position (e.g., a geo-location), an area associated with the position, travel speed, time of day, week, month, year, and/or the like. The server 140 may then determine (e.g., search and locate) the relevant network performance data associated with the operating location, operating travel speed, and/or current time and transmit such data to the mobile device 110 through the network 130.

In some embodiments, the expected network performance (as retrieved from the server 140) may include the network performance data corresponding to a position (and a predetermined area around the position) which may be the same position as the operating position. For example, network performance data associated with a mall (e.g., an area predetermined to be associated with the mall) may be used to assess the expected network performance of the mobile device 110 when the mobile device 110 has an operating position within the area predetermined to be associated with the mall. In another example, network performance data associated with a downtown (e.g., an area predetermined to be associated with the downtown) and a travel speed of 15 mph may be used to assess the expected network performance of the mobile device 110. The mobile device 110 may have an operating position within the area predetermined to be associated with the downtown, and the mobile device 110 may also have an operating travel speed within a predetermined ranged (e.g., within 5 mph, 10 mph, 15 mph, and/or the like) and/or a current time within a predetermined time interval (e.g., morning of weekdays, afternoon of weekdays, and evening of weekdays, and/or the like).

The network performance data may include at least one weighted factor indicating the average network performance by the various mobile devices (e.g., the first mobile device 110 and the additional mobile devices 120). The weighted factor may include various factors, each may correspond to an average uplink speed, average downlink speed, possibility to camp on a certain network (e.g., 3G, LTE, 4G, Wi-Fi, and/or the like). Each of these weighted factor may correspond to a specific position (and a predetermined area surrounding the specific position), a travel speed, time interval, and/or the like.

Next at block B540, the mobile device 110 may be configured to receive the network performance data from the remote server. The mobile device 110 may then designate the received network performance data, which corresponds to the operating position, operating travel speed, and the current time of the mobile device 110, as the expected network performance. As described, the expected network performance may correspond to the overall network resources context.

Next at block B550, the applications of the mobile device 110 may be prioritized based on the expected network performance as determined by B530 at least in the manner described with respect to blocks B250 and B440.

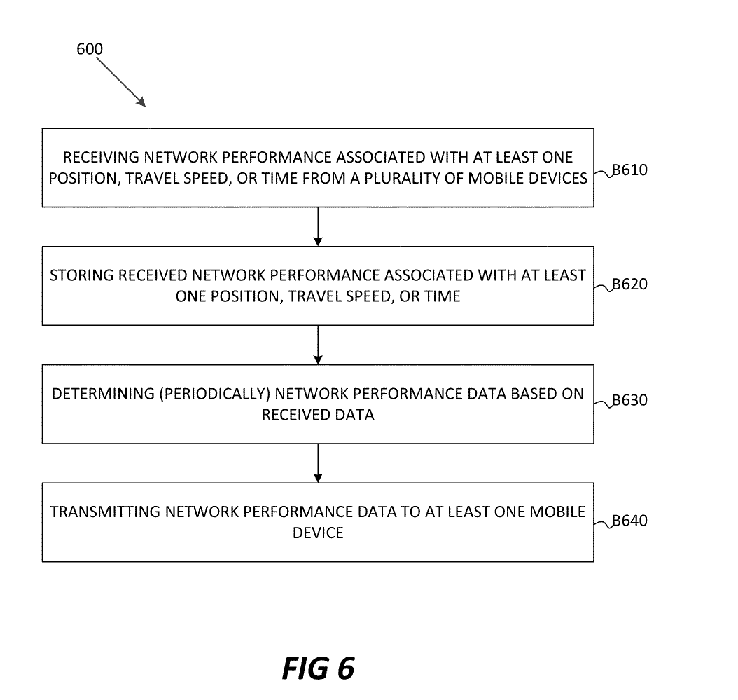

A method flowchart of an example of a mobile device application prioritization method 600 based on crowd-sourced network performance data is illustrated according to various embodiments in FIG. 6. In some embodiments, the mobile device application prioritization method 600 may be a method performed by a remote server (e.g., the server 140).

With reference to FIGS. 1-6, first at block B610, the server 140 may be configured to receive data related to network performance associated with at least one position, travel speed, and time from a plurality of mobile devices (e.g., the mobile device 110, the first mobile device 110, the additional mobile devices 120, and/or the like). Each of the plurality of mobile devices may transmit to the server 140 network performance, the first position associated with the network performance, the first travel speed associated with the network performance, and the first time at least in the manner described with respect to block B340. Accordingly, a plurality of network performance samples associating with different positions, different travel speeds, and different time may be received by the server 140. In other words, information regarding network performance of the plurality of mobile devices may be received. In some embodiments, the server 140 may receive a data unit from each of the plurality of mobile devices. The data unit may include at least the network performance associated with that mobile device and the position, travel speed associated, and time associated with the network performance.

In some embodiments, the server 140 may receive data from a same mobile device every time the mobile device enters a predetermined area (e.g., associated with a position, such as a mall, downtown area, theater, stadium, supermarket, parking lot, and/or the like). In other embodiments, the server 140 may receive data from a same mobile device every time the mobile device may be connected to a network (e.g., 3G, LTE, 4G, Wi-Fi, and/or the like). In other or further embodiments, the server 140 may be configured to receive data form a same mobile device periodically (e.g., every 30 minutes, 1 hour, 3 hours, 12 hours, 24 hours, and/or the like). Accordingly, a same mobile device may provide different performance data at different times of the day/week/month/year.

Next at block B620, the server 140 may be configured to store the received network performance associated with at least one position, travel speed, and time on a database on the server. The database may reside on the server 140, or it may be a remoter database located at a different node of the network 130.

Next at block B630, the server 140 may determine network performance data based on the received data. In some embodiments, the server 140 may categorize the positions received according to an associated area. The associated area may include the position. The server 140 may also categorize a travel speed into ranges of travel speeds. For example, the ranges may include a speed range of 0 mph-15 mph (not traveling), 15 mph-35 mph (low speed), 35 mph-55 mph (moderate speed), and/or 55 mph and up (high speed). The server 140 may similar categorize time periods for a day/week/month/year, such as, but not limited to: early morning, morning, noon, afternoon, evening, night, late night, weekdays, weekends, holidays, spring, summer, fall, winter, special-events days, a combination thereof, and/or the like. With respect to each category (and combination of categories), the server 140 may determine the network performance data include the type of network camped on, the type of network available, uplink speed, downlink speed, and/or the like. As such, the server 140 may index the received data according to what the various mobile devices may have experienced at a particular position, speed, and/or time. The server 140 may calculate a weighted average of the network speeds (e.g., uplink, downlink, and/or the like) with respect to a position, a travel speed, and/or time. The weighted average may be calculated from the data received from the various mobile devices. The server 140 may also determine the most-camped networks (or second-most-camped, etc.) associated with a position, travel speed, and/or time.

The weighted factors representing the network performance data may be one factor that takes into account of all the calculated aspects described. For example, the network performance data may be a weighted factor (network score) of 86 out of 100 (100 being an excellent network environment) associated with any mobile device in a mall, not in motion (e.g., below 15 mph), in a morning during a weekday in spring. In other embodiments, each of the uplink speed, downlink speed, type of network, and/or the like may be associated with one or more weighted factors.

The server 140 may periodically calculate/recalculate the weighted averages, as the data from the various mobile devices (as well as further new mobile devices) are received. This assures that the weighted factors, network score, network performance data is up to date. In some embodiments, the weighted factors, network score, network performance data, and/or the like may be calculated based on only recent data (e.g., data obtained in the last week, month, half a year, year, and/or the like).

Next at block B640, the server 140 may be configured to transmit the network performance data to at least one mobile device (e.g., the first mobile device 110, the additional mobile devices 120, the mobile device 110, and/or the like). The server 140 may transmit such data over the network 130.

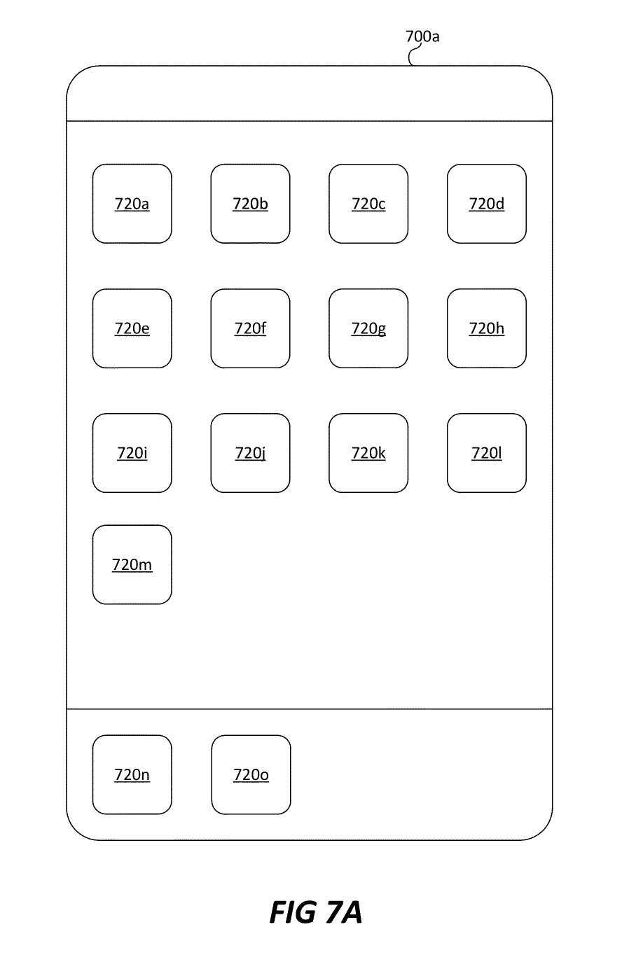

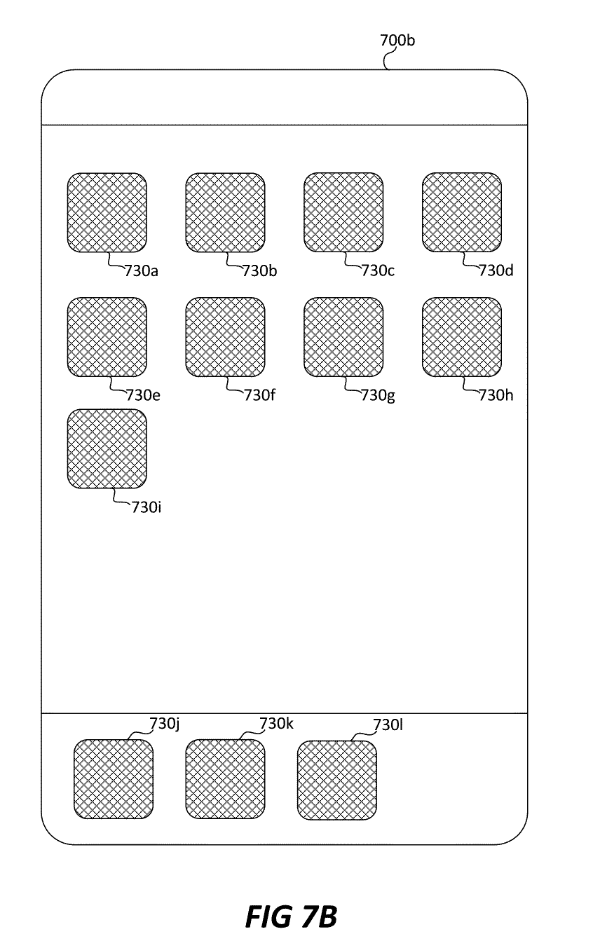

FIGS. 7A and 7B illustrates example screens displaying prioritized and/or unprioritized applications. Referring to FIGS. 1-7B, illustrated are a first screen 700a and a second screen 700b (both of which may be displayed by the user interface 115) including various icons, each representing a different application (e.g., a different one of shifted prioritized applications 720a-720o, shifted unprioritized applications 730a-730l, and/or the like) of the mobile device 110. The icons may be configured as user interactive elements.

In some embodiments, the prioritized applications (e.g., the shifted prioritized applications 720a-720o) may be configured to be easily accessible. On the other hand, unprioritized elements (e.g., the shifted unprioritized applications 730a-730l) may be more burdensome to access or even non-responsible when accessed through the user interface 115. The first screen 700a and the second screen 700b may be different screens. Each of the first screen 700a and the second screen 700b may include therein different application icons. In some embodiments, the first screen 700a may be a default or initial screen displayed by the user interface 115. In other words, a user may not be required to switch screens (or not required to switch too many screens) to reach the first screen 700a. The second screen 700b may be one of at least screens arranged to be viewable after viewing of the default or initial screen (e.g., a subsequent screen, such as the first screen 700a).

For example, the shifted prioritized applications 720a-720o may be shifted to at least one initial screen (e.g., the first screen 700a). At least one of the shifted prioritized applications 720a-720o may have been shifted from another screen different to the first screen 700a. In addition, at least one of the shifted prioritized applications 720a-720o may be arranged in a different position on a screen. This may occur due to one or more of the shifted unprioritized applications 730a-730l being shifted away from between two or more of the shifted prioritized applications 720a-720o.

The shifted unprioritized applications 730a-730l may be shifted to at least one subsequent screens (e.g., the second screen 700b). At least one of the shifted unprioritized applications 730a-730l may have been shifted from another screen different to the second screen 700b. In addition, at least one of the shifted unprioritized applications 730a-730l may be arranged in a different position on a screen. This may occur due to one or more of the shifted prioritized applications 720a-720o being shifted away (e.g., to the first screen 700a) from between two or more of the shifted unprioritized applications 730a-730l.

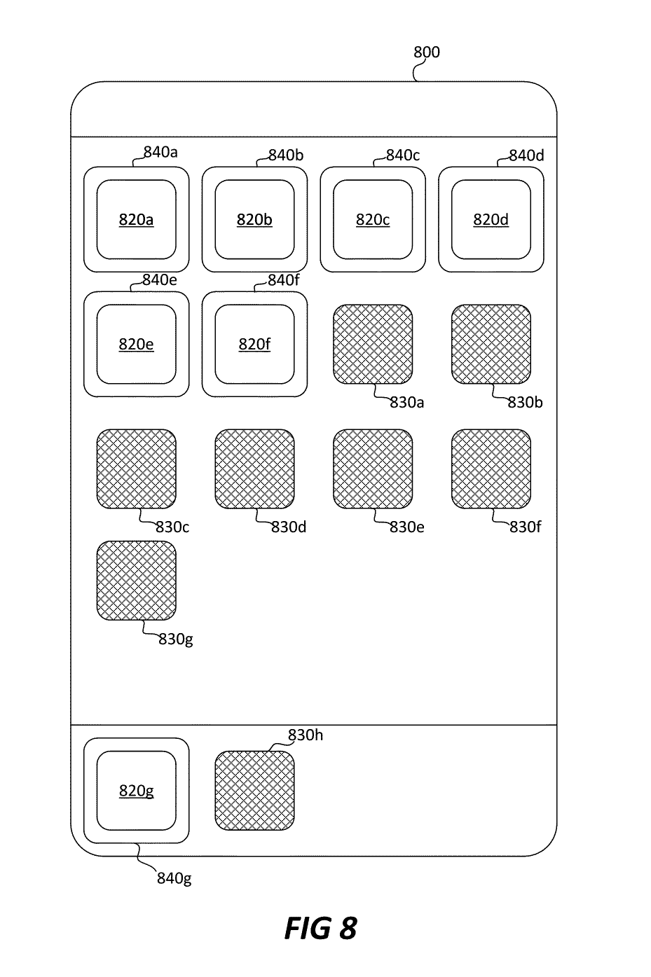

FIG. 8 is another example screen 800 displaying prioritized and/or unprioritized applications. Referring to FIGS. 1-8, illustrated is the screen 800 (displayed by the user interface 115) including various icons, each representing a different application (e.g., a different one of prioritized applications 820a-820g, unprioritized applications 830a-830h, and/or the like) of the mobile device 110. The icons may be configured as user interactive elements.

In some embodiments, the prioritized applications 820a-820g may be arranged or otherwise ordered on the screen before the unprioritized applications 830a-830h. In other embodiments, the prioritized applications 820a-820g may be arranged in the substantial center of the screen while the unprioritized applications 830a-830h may be arranged to surround the prioritized applications 830a-830h.

In some embodiments, the prioritized applications 820a-820g may be represented in a first graphical state (e.g., in a first color or of a boxed form) indicating priority, while the unprioritized applications 830a-830h may appear in a different graphical state (e.g., in a second color which is different from the first, unboxed, or shaded in). For example, the prioritized applications 820a-820g may be in a normal graphical state (e.g., the graphical state of the application icons of both the prioritized the prioritized applications 820a-820g and the unprioritized applications 830a-830h before the prioritization method is triggered). The unprioritized applications 830a-830h may be in a shaded or blacked-out state, indicating to the user that these applications are not prioritized or suggested. Additionally, prioritized applications 820a-820g may include added graphical features such as the green squares 840a-840g (or of other shapes/colors) to distinguish from the unprioritized applications 830a-830h.

In some embodiments, a unprioritized application 830a-830h may be unresponsive when the user attempts to interact with them. In various embodiments, the unprioritized application 830a-830h may not be displayed by the user interface 115 at all.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to some embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for prioritizing a plurality of applications associated with a mobile device, the method comprising:
determining at least one attribute associated with each of the plurality of applications, the at least one attribute comprising at least one of battery power consumption, quality of service (QOS) requirement, uplink speed requirement, downlink speed requirement, or processing power consumption;
detecting a triggering event;
determining expected device resources, the expected device resources indicate projected device resources available for executing the plurality of applications in response to the triggering event; and
prioritizing applications from the plurality of applications based on the expected device resources and the at least one attribute associated with each of the plurality of applications.

2. The method of claim 1, further comprising
determining at least one of a current position, current travel speed, or current time in response to the triggering event; wherein:
the expected device resources comprises expected network performance data; and
the expected network performance data is associated with a plurality of secondary mobile devices.

3. The method of claim 2, wherein the expected network performance data comprises at least one of expected network type, expected uplink speed, or expected downlink speed associated with at least one of a plurality of positions, a plurality of travel speed ranges, or a plurality of time intervals.

4. The method of claim 3, wherein the determining the expected network performance data comprises at least one of:
matching the current position with one of the plurality of positions;
matching the current travel speed with one of the plurality of travel speed ranges; or
matching the current time to one of the plurality of time intervals.

5. The method of claim 4, wherein the determining the expected network performance data further comprises retrieving the expected network performance data based on one or more of the matched position of the plurality of positions, the matched travel speed range of the plurality of travel speed ranges, and the matched time interval of the plurality of time intervals.

6. The method of claim 2, wherein the expected network performance data is an average network performance data determined based on secondary network performance data associated with each of the plurality of secondary mobile devices.

7. The method of claim 2, wherein the prioritizing applications from the plurality of applications based on the expected device resources and the at least one attribute associated with each of the plurality of applications comprises:
selecting prioritized applications from the plurality of applications based on the expected network performance and the at least one attribute associated with each of the plurality of applications.

8. The method of claim 2, further comprising transmitting an actual network performance and at least one of the current position, the current travel speed, or the current time to a remote server.

9. The method of claim 8, wherein the actual network performance and the at least one of the current position, the current travel speed, or the current time are transmitted to a remote server in a same data unit.

10. The method of claim 9, further comprising receiving expected network performance from the remote server.

11. The method of claim 1, wherein the determining the at least one attribute comprises
monitoring the application for a predetermine period of time;
storing sample values associated with the attribute; and
determining an attribute average value based, at least in part, on the sample values.

12. The method of claim 1, wherein the triggering event comprises at least one of:
the mobile device entering or exiting a predetermined area;
the mobile device arriving at a predetermined position;
the mobile device entering or existing the predetermine area while traveling at a predetermined speed;
the mobile device is entering or existing the predetermine area within a predetermined time interval; or
the mobile device is entering or existing the predetermined area while traveling at a predetermined speed and within the predetermined time interval.

13. The method of claim 1, wherein the triggering event comprises at least one of:
the mobile device being camped on a predetermined network;
the mobile device having a predetermined uplink speed; or
the mobile device having a predetermined download speed.

14. The method of claim 1, further comprising prioritizing the prioritized applications, wherein the prioritizing the prioritized applications comprises at least one of:
shifting the prioritized applications to at least one initial screen;
displaying the prioritized applications before displaying at least one un-prioritized application; or
displaying the prioritized applications in a first graphical state, displaying the un-prioritized applications in a second graphical state, wherein the first graphical state and the second graphical state are different graphical states.

15. An mobile device, the mobile device comprises:
a processor, the processor configured to:
determine at least one attribute associated with each of the plurality of applications, the at least one attribute comprising at least one of battery power consumption, quality of service (QOS) requirement, uplink speed requirement, downlink speed requirement, or processing power consumption;
detect a triggering event;
determine expected device resources, the expected device resources indicate projected device resources available for executing the plurality of application in response to the triggering event; and
select prioritized applications from the plurality of applications based on the expected device resources and the at least one attribute associated with each of the plurality of applications.

16. The mobile device of claim 15 the processor is further configured to:
determine at least one of a current position, current travel speed, or current time in response to the triggering event; wherein:
the expected device resources comprises expected network performance data; and
the expected network performance data is associated with a plurality of secondary mobile devices.

17. The mobile device of claim 16, wherein the expected network performance data comprises at least one of expected network type, expected uplink speed, or expected downlink speed associated with at least one of a plurality of positions, a plurality of travel speed ranges, or a plurality of time intervals.

18. The mobile device of claim 17, wherein the determining the expected network performance data comprises at least one of:
matching the current position with one of the plurality of positions;
matching the current travel speed with one of the plurality of travel speed ranges; or
matching the current time to one of the plurality of time intervals.

19. The method of claim 18, wherein the determining the expected network performance data further comprises retrieving the expected network performance data based on one or more of the matched position of the plurality of positions, the matched travel speed range of the plurality of travel speed ranges, and the matched time interval of the plurality of time intervals.

20. An apparatus, comprising:
means for determining at least one attribute associated with each of the plurality of applications, the at least one attribute comprising at least one of battery power consumption, quality of service (QOS) requirement, uplink speed requirement, downlink speed requirement, or processing power consumption;
means for detecting a triggering event;
means for determining expected device resources, the expected device resources indicate projected device resources available for executing the plurality of application in response to the triggering event; and
means for prioritizing applications from the plurality of applications based on the expected device resources and the at least one attribute associated with each of the plurality of applications.
